(19) United States
(12) Patent Application Publication
(10) Pub. No.: US 2012/0128538 A1
(43) Pub. Date: May 24, 2012

(54) ADJUSTABLE PRESSURE MICROREACTOR

(76) Inventors: Seth Miller, Englewood, CO (US); Ezekiel Kruglick, Poway, CA (US)

(21) Appl. No.: 12/999,100

(22) PCT Filed: Jun. 9, 2010
(86) PCT No.: PCT/US10/37919

§ 371 Date: Dec. 15, 2010

(51) Int. Cl. B01J 19/00; F15D 1/00

(52) U.S. Cl. 422/105; 422/242; 422/119; 137/14

(57) ABSTRACT

Technologies are generally described for adjusting a pressure in a microreactor system. An example microreactor system may include a reaction chamber, wherein the reaction chamber is effective to receive at least one reactant, and carry out a reaction on the reactant to produce a product. An example method may comprise controlling a first electroosmotic pump to drive a first fluid toward the reaction chamber with a first force. In some examples. the method may further comprise controlling a second electroosmotic pump to drive a second fluid toward the reaction chamber with a second force. In some examples, the method may further comprise carrying out the reaction on the reactants in the reaction chamber to produce the product. The first and the second forces may be effective to generate a pressure inside the reaction chamber, where the pressure is greater than one atmosphere.

### BACKGROUND

Unless otherwise indicated herein, the materials described in this section are not prior art to the claims in this application and are not admitted to be prior art by inclusion in this section.

In chemical reactions, reactants are moved to a reaction chamber. In the reaction chamber, a reaction can be carried out on the reactants to produce a product. Some reactions may be performed with pressures in the reaction chamber that are higher than one atmosphere. For example, reactions where the product is smaller than the starting reactants may benefit from increased pressure.

### SUMMARY

In one example, a method is described for adjusting a pressure in a microreactor system. In some examples, the microreactor system may include a reaction chamber. In some examples, the reaction chamber may be effective to receive at least one reactant, and carry out a reaction on the reactant to produce a product. In some examples, the method includes controlling a first electroosmotic pump to drive a first fluid toward the reaction chamber with a first force. In some examples, the method further includes controlling a second electroosmotic pump to drive a second fluid toward the reaction chamber with a second force. In some examples, the method further includes carrying out the reaction on the reactants in the reaction chamber to produce the product. In some examples, the reaction is carried out while the first electroosmotic pump drives the first fluid toward the reaction chamber and while the second electroosmotic pump drives the second fluid toward the reaction chamber. In some examples, the first and the second threes are effective to generate a pressure inside the reaction chamber, the pressure being greater than one atmosphere.

In another example, an adjustable pressure microreactor system is described. In some examples, the system includes a reaction chamber including a first port and a second port. In some examples, the system includes a first channel in fluid communication with the first port. In some examples, the system includes a second channel in fluid communication with the second port. In some examples, the system includes a first electroosmotic pump configured to drive a first fluid toward the reaction chamber via the first channel with a first force. In some examples, the system includes a second electroosmotic pump configured to drive a second fluid toward the reaction chamber via the second channel with a second force. In some examples, the reaction chamber, the first channel, the second channel, the first electroosmotic pump and the second electroosmotic pump are configured in cooperation with one another such that first and the second forces are effective to generate a pressure inside the reaction chamber, the pressure being greater than one atmosphere.

In yet another example, a computer storage medium is described having computer-executable instructions stored thereon which, when executed by a computing device, adapt the computing device to perform a method for adjusting a pressure in a microreactor system. In some examples, the microreactor system includes a reaction chamber. In some examples, the reaction chamber is effective to receive at least one reactant, and carry out a reaction on the reactant to produce a product. In some examples. the method includes controlling a first electroosmotic pump to drive a first fluid toward the reaction chamber with a first force. In some examples, the method further includes controlling a second electroosmotic pump to drive a second fluid toward the reaction chamber with a second force. In some examples, the method further includes carrying out the reaction on the reactants in the reaction chamber to produce the product. In some examples, the reaction is carried out while the first electroosmotic pump drives the first fluid toward the reaction chamber and while the second electroosmotic pump drives the second fluid toward the reaction chamber. In some examples, the first and the second forces are effective to generate a pressure inside the reaction chamber, the pressure being greater than one atmosphere.

In still yet another example, an adjustable pressure microreactor system is described. In some examples, the system includes a reaction chamber including a first port and a second port. In some examples, the system includes a first channel in fluid communication with the first port. In some examples, the system includes a second channel in fluid communication with the second port. In sonic examples, the system includes a flexible membrane disposed in the second channel. In some examples, the system includes a first electroosmotic pump configured to drive a first fluid toward the reaction chamber via the first channel. In sonic examples, the system includes a second electroosmotic pump in fluid communication with the flexible membrane. In some examples, the second electroosmotic pump includes a second fluid and is configured to selectively move the second fluid to expand the membrane and decrease an opening of the second channel so that, in cooperation with the reaction chamber, the first channel, the second channel, and the first electroosmotic pump, a pressure is generated inside the reaction chamber that is greater than one atmosphere.

In yet another example, a method is described for adjusting a pressure in a microreactor system. In some examples, the microreactor system includes a reaction chamber. In sonic examples, the reaction chamber is effective to receive at least one reactant, and carry out a reaction on the reactant to produce a product. In some examples, the reaction chamber includes a first opening in fluid communication with a first channel and a second opening in fluid communication with a second channel. In some examples, the method includes controlling a first electroosmotic pump to drive a first fluid toward the reaction chamber with a first force. In some examples, the method includes controlling a second electroosmotic pump to move a second fluid to expand a membrane inside the second channel and decrease an opening of the second channel so that a pressure is generated inside the reaction chamber that is greater than one atmosphere. In some examples, the method includes carrying out the reaction on the reactants in the reaction chamber to produce the product. In some examples, the reaction is carried out while the first electroosmotic pump drives the first fluid toward the reaction chamber and while the second electroosmotic pump moves the second fluid to expand the membrane.

In still yet another example, a computer storage medium is described having computer-executable instructions stored thereon which, when executed by a computing device, adapt the computing device to perform a method for adjusting a pressure in a microreactor system. In some examples, the microreactor system includes a reaction chamber. In some examples, the reaction chamber is effective to receive at least one reactant, and carry out a reaction on the reactant to produce a product. In some examples, the reaction chamber includes a first opening in fluid communication with a first channel and a second opening in fluid communication with a second channel. In some examples, the method includes controlling a first electroosmotic pump to drive a first fluid toward the reaction chamber with a first force. In some examples, the method includes controlling a second electroosmotic pump to move a second fluid to expand a membrane inside the second channel and decrease an opening of the second channel so that a pressure is generated inside the reaction chamber that is greater than one atmosphere. In some examples, the method includes carrying out the reaction on the reactants in the reaction chamber to produce the product. In some examples, the reaction is carried out while the first electroosmotic pump drives the first fluid toward the reaction chamber and while the second electroosmotic pump moves the second fluid to expand the membrane.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope. the disclosure will be described with additional specificity and detail through use of the accompanying drawings, in which:

FIG. 1 illustrates an example adjustable pressure microreactor;

FIG. 2 illustrates an example adjustable pressure microreactor;

FIG. 3 illustrates an example adjustable pressure microreactor;

FIG. 4 depicts a flow diagram for an example process for an adjustable pressure microreactor;

FIG. 5 illustrates a computer program product for an adjustable pressure microreactor; and

FIG. 6 is a block diagram illustrating an example computing device that is arranged to control an adjustable pressure microreactor; all arranged according to at least some embodiments presented herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and computer program products related to an adjustable pressure microreactor.

Briefly stated, technologies are generally described for adjusting a pressure in a microreactor system. An example microreactor system may include a reaction chamber, wherein the reaction chamber is effective to receive at least one reactant, and carry out a reaction on the reactant to produce a product. An example method may comprise controlling a first electroosmotic pump to drive a first fluid toward the reaction chamber with a first force. In some examples, the method may further comprise controlling a second electroosmotic pump to drive a second fluid toward the reaction chamber with a second force. In some examples, the method may further comprise carrying out the reaction on the reactants in the reaction chamber to produce the product. The first and the second forces may be effective to generate a pressure inside the reaction chamber, where the pressure is greater than one atmosphere.

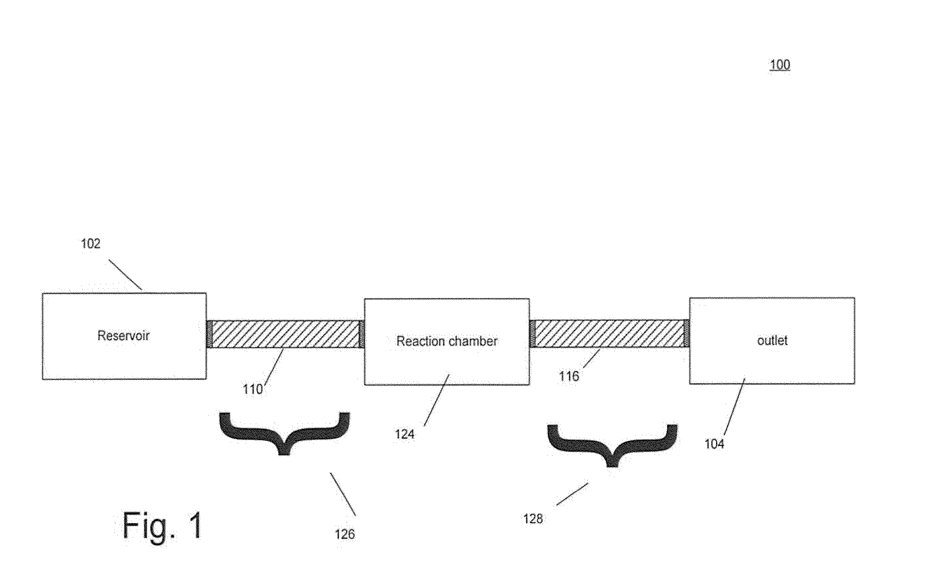

FIG. 1 illustrates an example adjustable pressure microreactor that is arranged in accordance with at least some embodiments presented herein. As is described in more detail below, adjustable pressure microreactor system 100 may include one or more of a reservoir 102, a reaction chamber 124, an outlet 104, channels 110, 116 and pumps 126, 128. Reservoir 102 and reaction chamber 124 are in fluid communication through channel 110. Reaction chamber 124 and outlet 104 are in fluid communication through channel 116. Pumps 126 and 128 may be disposed in channels 110, 116 respectively and controlled to adjust a pressure inside reaction chamber 124 so that the pressure may be controlled to be greater than one atmosphere.

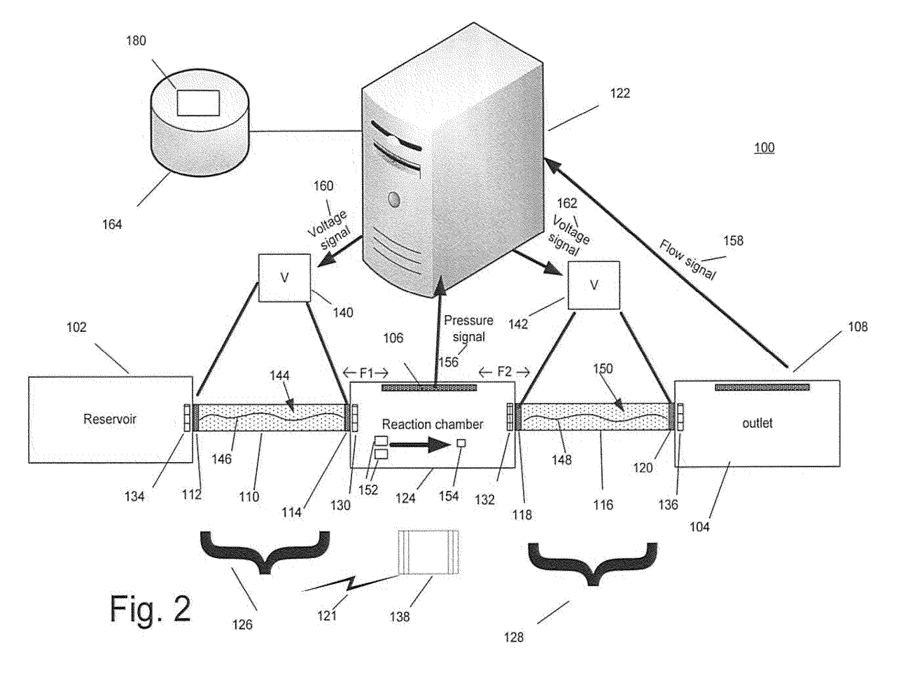

FIG. 2 illustrates an example adjustable pressure microreactor in accordance with at least some embodiments presented herein. The system of FIG. 2 is substantially similar to system 100 of FIG. 1, with additional details. Those components in FIG. 2 that are labeled identically to components of FIG. 1 will not be described again for the purposes or clarity.

As illustrated in FIG. 2, system 100 may further include a processor 122 configured in communication with a memory 164, and voltage sources 140, 142. Reservoir 102 may include a port 134. Reaction chamber 124 may include ports 130, 132 and a pressure sensor 106, where the pressure sensor 106 may be configured in communication with processor 122. A heat source 138 may be disposed proximate to reaction chamber 124 and configured in communication with processor 122 through, for example, a communication link 121 . Outlet 104 may include a port 136 and a flow sensor 108, where the flow sensor 108 may be configured in communication with processor 122. Pressure sensor 106 and flow sensor 108 may be configured in communication with processor 122. Pump 126 may be an electroosmotic pump disposed in channel 110 and including electrodes 112, 114, electrolyte solution 146 and dielectric solids 144. Similarly, pump 128 may be electroosmotic pump disposed in channel 116 and including electrodes 118, 120, electrolyte solution 148 and dielectric solids 150.

When performing a chemical reaction, reactants 152 may be moved to reaction chamber 124. In some examples, reactants 152 may be in electrolyte solution 146. A reaction may he carried out on reactants 152 to produce a product 154. Product 154 may thereafter be moved outside of reaction chamber 124. As discussed in more detail below, pumps 126, 128 may be used to increase a pressure inside reaction chamber 124 to a pressure greater than one atmosphere. Moreover, pumps 126, 128 may be configured to move product 154 outside of reaction chamber 124. Electrolyte solution 146, 148 may start in reservoir 102. Thereafter, electrolyte solution 146, 148 may be moved to reaction chamber 124 through port 134, channel 110, and port 130. After the reaction is carried out on reactants 152, product 154 may be moved by electrolyte 146, 148 though port 132, channel 116, port 136 and into outlet 104.

Electroosmotic pumps 126, 128 may be configured to increase pressure in reaction chamber 124 during a reaction. Voltage source 140 may be configured in communication with electrodes 112, 114 of pump 126. Similarly, voltage source 142 may be configured in communication with electrodes 118, 120 of pump 128. Voltage sources 140, 142 may be configured to generate voltages across electrodes 112, 114 to cause ions to move in an alternating current circuit, a direct current circuit, or any combination thereof. In some examples, channels 110 and 116 may be packed with porous dielectric microparticles or nanoparticles 144, 150 such as silica. Some examples of particles 144, 150 may include silica, alumina, zirconia, ceria, titania, zinc oxide, or other particles stable in the solvent system. Particles with a large zeta potential in the solvent(s) may be used to maximize the pressure deliverable by the electroosmotic pumps. Any fluid may be used for electrolyte solution 146, 148 such as such as water, methanol, ethanol, acetonitrile, DMF (dimethylformamide), DMSO (dimethylsulfoxide), etc. The fluid may include a salt

Application of a voltage from voltage source 140 across electrodes 112, 114, may result in moving positive ions in solution 146 toward a negatively charged electrode 112, 114. Similarly, application of a voltage from voltage source 142 across electrodes 118, 120, may result in moving positive ions in solution 148 toward a negatively charged electrode pair 118, 120. Movement of the ions may, in turn, move all or a portion of the rest of solution 146, 148 clue to viscous interaction between the ions and the rest of solution 146, 148.

By modifying a voltage from voltage sources 140, 142 and/or adjusting a choice of electrolyte solution 146, 148 or the PH of electrolyte solution 146, 148, fluids in pumps 126, 128 may be selectively moved toward desired directions. Packing pumps 126, 128 with particles 144, 150 may increase an interfacial area between the dielectric in particles 144, 150 and electrolyte solution 146, 148. As the ions in solution 146, 148 move when the ions interact with a dielectric, this packing may result in stronger fluid flow due to the electroosmotic process.

In use, processor 122 may be configured to generate voltage signals 160, 162 effective to control voltage sources 140, 142. Voltage sources 140, 142, may be adapted to drive or move electrolyte solutions 146, 148 by generating voltage potential differences across electrodes 112 and 114 and across electrodes 118 and 120. In some examples, processor 122 may be configured to control voltage source 140 effective to drive electrolyte 146 from reservoir 102 toward reaction chamber 124 (to the right in the figure). The driving generates a force F1 toward reaction chamber 124. Processor 122 may be adapted to control voltage source 142 to drive electrolyte 146 from reaction chamber 124 toward outlet 104 (to the right in the figure). The driving generates a force F2 away from reaction chamber 124. In these examples, electrolyte 146, 148 may continuously flow through reaction chamber 124 and product 154 may be moved out of reaction chamber 124.

In other examples, processor 122 may be configured to control voltage source 140 to drive electrolyte 146 from reservoir 102 toward reaction chamber 124 (to the right in the figure). In these examples, processor 122 may be configured to control voltage source 142 to drive electrolyte 148 toward reaction chamber 124 (to the left in the figure). In these examples, electrolyte solution 146 and 148 both are driven toward reaction chamber 124 and forces F1 and F2 both act upon reaction chamber 124. In examples where fluid/electrolyte solution 146, 148 are the same and voltages output from voltage sources 140, 142 arc substantially equal, forces F1 and F2 are substantially equal and fluid 146, 148 tends to remain in reaction chamber 124. However, application of forces F1 and F2 on reaction chamber 124 may result in increased pressure inside reaction chamber 124. Further increasing voltages output by voltage sources 140, 142 may result in increase of pressure inside reaction chamber 124, thereby facilitating reactions. Heat source 138 may be configured to generate heat in reaction chamber 124 and may further facilitate reactions in reaction chamber 124. In these examples, microrcactor system 100 may be configured to operate in a semi-continuous manlier, where reactants 152 may be moved into reaction chamber 124, a reaction may be carried out, and product 154 may be moved out of reaction chamber 124.

In some examples, adjusting, a voltage output from one or more voltage sources 140, 142 can create an imbalance in forces F1, F2 applied by fluid 146 compared with fluid 148. For example, a lower voltage may be output by voltage source 142 than by voltage source 140, where forces F1 and F2 may still be applied toward reaction chamber 124 but with different magnitudes. In this example, force F1 may be greater than force F2, and the imbalance in forces may be configured such that microreactor system 100 may operate in a continuous manner where reactants 152 and products 154 are continuously moved through reaction chamber 124 by electrolyte solutions 146, 148. As a result of forces F1 and F2 acting upon reaction chamber 124 a high pressure can be maintained in reaction chamber 124.

Pressure sensor 106 may be adapted to generate a pressure signal 156. Pressure signal 156 may indicate a pressure inside reaction chamber 124. Pressure signal may 156 be sent to processor 122. In response to pressure signal 156, processor 122 may be adapted to control voltage signals 162 to control fluids 146, 148 and the pressure inside reaction chamber 124.

Flow sensor 108 may be adapted to generate flow signal 158. Flow signal 158 may indicate a speed of a fluid flow of electrolyte solution 148 in outlet 104. Flow signal 158 may be sent to processor 122, where processor 122 may be responsively adapted to control voltage signals 162 to control the flow of electrolyte 148 through outlet 104. In some examples, flow sensor 108 may be a piezoelectric film.

As mentioned above, processor 122 may be adapted to generate voltage signals 160, 162 in response to flow signal 168 and/or pressure signal 162. Additionally, processor 122 may be adapted to generate voltage signals 160, 162 and control flow of electrolyte solutions 146, 148 based on a set of instructions 180 stored in memory 164. In some examples, instructions 180 could indicate pressure, flow and heat for a particular reaction. Processor 122 may thus be configured to adjust voltage signals 160, 162 based on one or more of flow signal 168, pressure signal 162, and/or instructions 180. Processor 122 may also be adapted to adjust heat output from heat source 138.

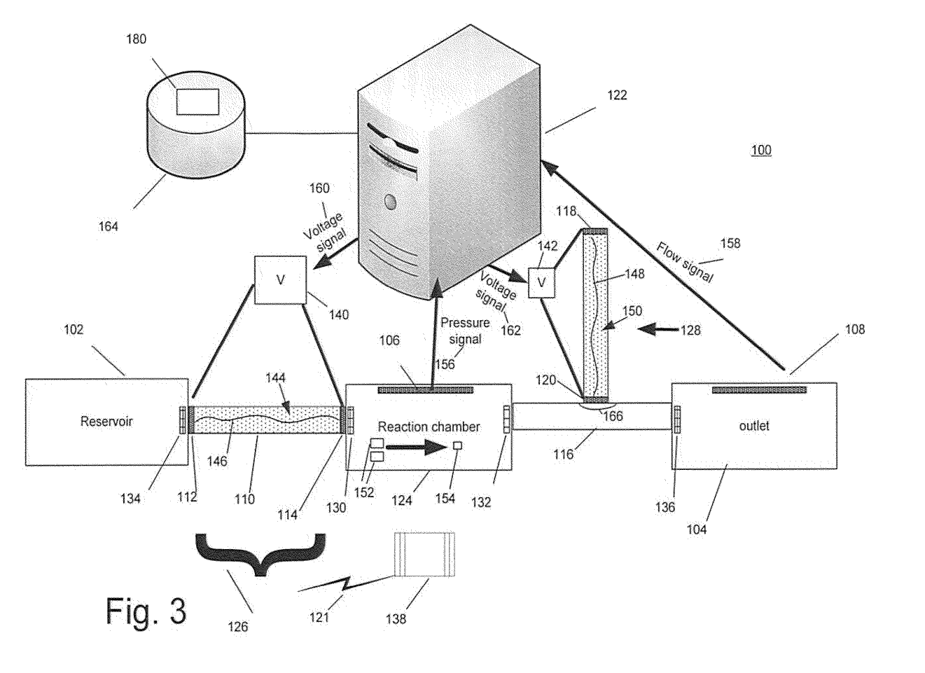

FIG. 3 illustrates an example adjustable pressure microrcactor in accordance with at least some embodiments presented herein. The system of FIG. 3 is substantially similar to system 100 of FIGS. 1 and 2, with additional details. Those components in FIG. 3 that are labeled identically to components of FIGS. 1 and 2 will not be described again for the purposes of clarity.

As shown in FIG. 3, in some examples. pump 128 may be disposed external to and in fluid communication with channel 116. In these examples, a flexible membrane 166 may be disposed in channel 116 and adapted in fluid communication with pump 128. Upon application of voltage from power source 142, fluid 148 may move toward membrane 166 thereby causing membrane 166 to expand. By expanding membrane 166, an opening of channel 116 can be decreased. Membrane 166 thus can lie configured to act like an adjustable valve. In examples where membrane 166 is expanded while fluid 146 is flowing through reaction chamber 124 and into outlet 104, membrane 166 is configured to resist the flow of fluid 146. Membrane 166 may be expanded to inhibit a flow of fluid 146 completely and thereby allow a reaction to occur on reactants 152 at a pressure higher than one atmosphere. Once product 154 is produced, voltage output by voltage source 142 may be decreased or a polarity of the voltage may be changed (e.g., under control of processor 122). This may result in less solution 148 moving and a contracting of membrane 166. With membrane 166 contracted, fluid 146 may move product 154 out of reaction chamber 124. hi some examples, membrane 166 is made out of PDMS (polydimethylsiloxane).

Among other benefits, system 100 is configured to facilitate pressure in reaction chamber 124 as an adjustable parameter which may result in higher throughput, higher yield chemical reactions. Non-commercial, lab scale chemistry can benefit from system 100 in that high pressures are made available more easily and safely and without necessitating sophisticated training. Increasing pressure means that higher yield and throughput are available. System 100 may be used in a batch or semi-continuous process with time spaces in between reactions and/or in a continuous process where reactants are continually fed and reactions are carried out. In some examples, using solution 100 allows high pressure reactions to be carried out in microreactors. Among other things, this disclosure describes pumps that may be connected to microreactor devices. Such a connection might be difficult to realize without the benefits of this disclosure.

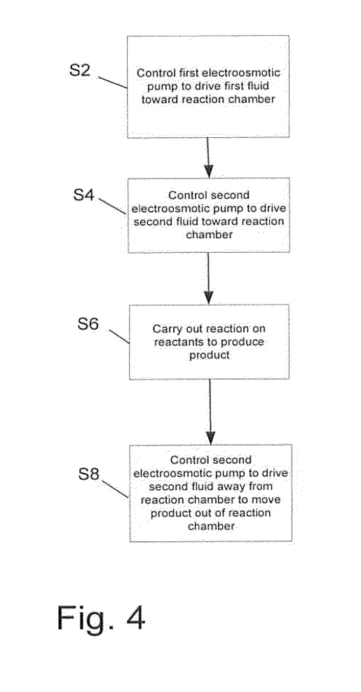

FIG. 4 depicts a flow diagram for an example process for an adjustable pressure microreactor in accordance with at least some embodiments presented herein. The process in FIG. 4 could be implemented using, for example, system 100 discussed above. An example process may include one or more operations, actions, or functions as illustrated by one or more of blocks S2, S4, S6 and/or SS. Although illustrated as discrete blocks, various blocks may be divided into additional blocks, combined into fewer blocks, or eliminated, depending on the desired implementation. Processing may begin at block S2.

At block S2, a first electroosmotic pump may be controlled (e.g., via processor 122) to drive a first fluid toward a reaction chamber. Processing may continue from block S2 to block S4.

At block S4, a second electroosmotic pump may be controlled (e.g., via processor 122) to drive a second fluid toward the reaction chamber. Processing may continue from block S4 to block S6.

At block S6, a reaction may be carried out on the reactants in the reaction chamber to produce a product. Processing may continue from block S6 to block S8.

At block S8, the second electroosmotic pump may be controlled (e.g., under control of processor 122) to drive the second fluid away from the reaction chamber such that the product is moved out of the reaction chamber.

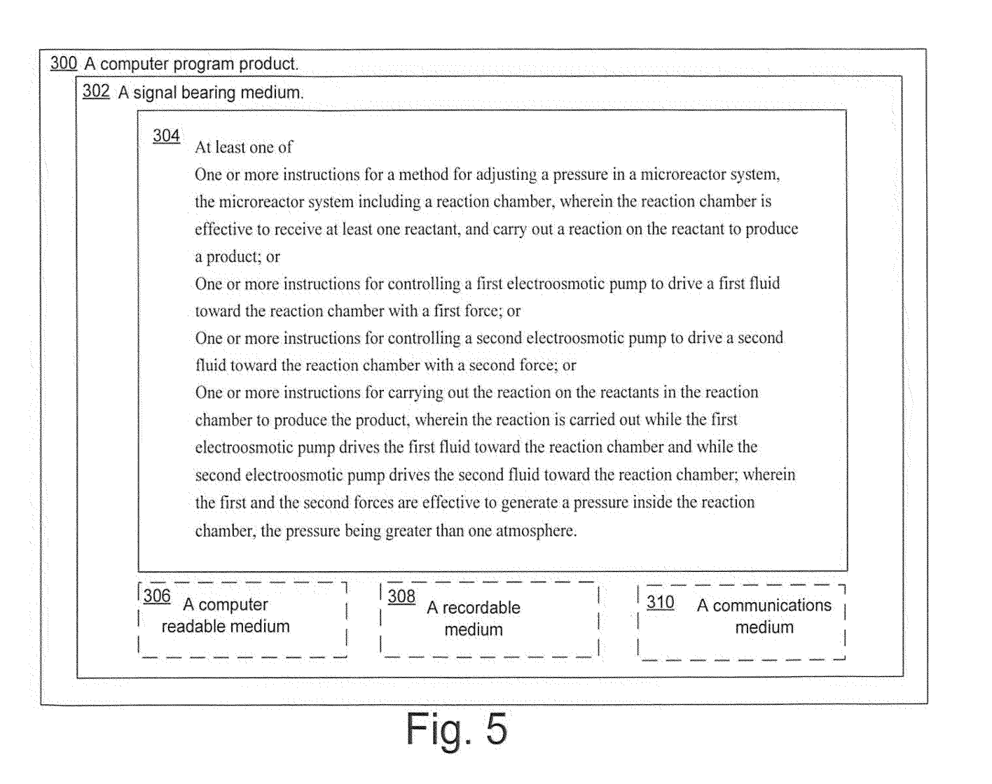

FIG. 5 illustrates an example computer program product 300 arranged in accordance with at least some examples of the present disclosure. Program product 300 may include a signal bearing medium 302. Signal bearing medium 302 may include one or more instructions 304 that, when executed by, for example, a processor, may provide the functionality described above with respect to FIGS. 1-4. Thus, for example, referring to system 100, processor 122 may undertake one or more of the blocks shown in FIG. 4 in response to instructions 304 conveyed to the system 100 by medium 302.

In some implementations, signal bearing medium 302 may encompass a computer-readable medium 306, such as, but not limited to, a hard disk drive, a Compact Disc (CD), a Digital Video Disk (DVD). a digital tape, memory, etc. In some implementations, signal bearing medium 302 may encompass a recordable medium 308, such as, but not limited to, memory, read/write (R/W) CDs, R/W DVDs. etc. In some implementations, signal bearing medium 302 may encompass a communications medium 310, such as, but not limited to, a digital and/or an analog communication medium (e.g., a fiber optic cable, a waveguide, a wired communications link, a wireless communication link, etc.). Thus, for example, program product 300 may be conveyed to one or more modules of the system 100 by an RF signal bearing medium 302, where the signal bearing medium 302 is conveyed by a wireless communications medium 310 (e.g., a wireless communications medium conforming with the IEEE 802.11 standard).

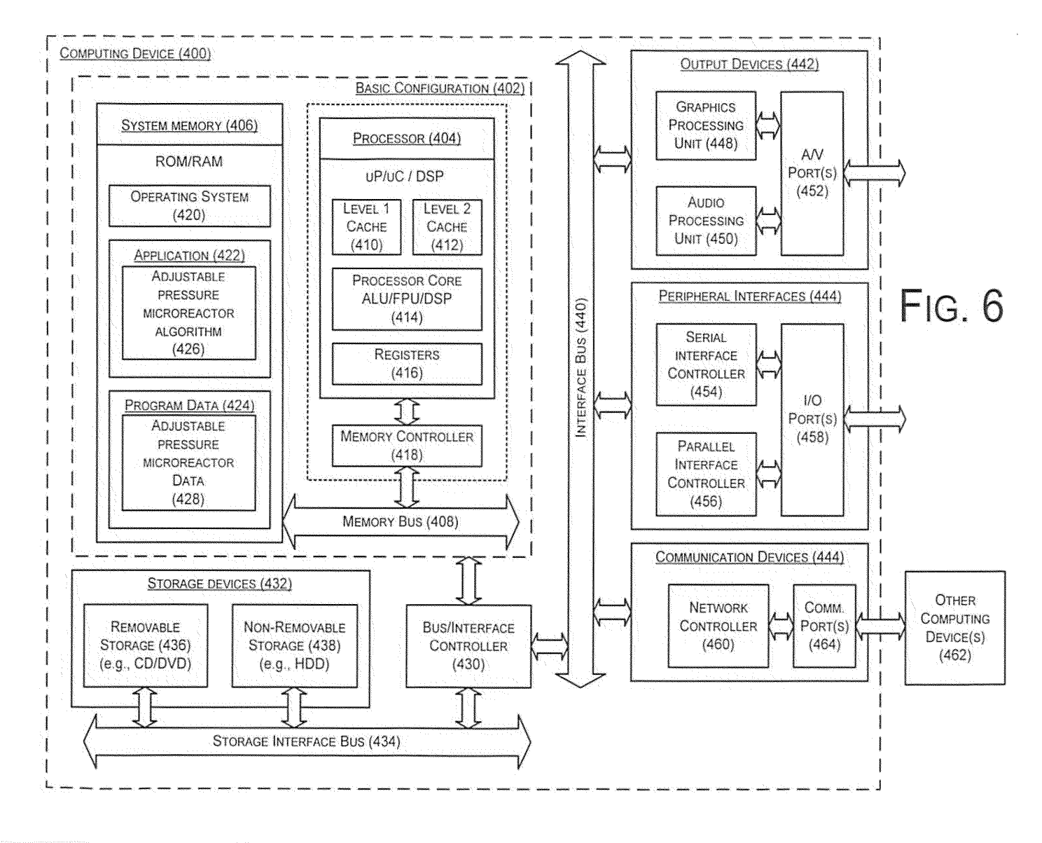

FIG. 6 is a block diagram illustrating an example computing device 400 that is arranged to perform adjusting of pressure in a microreactor in accordance with the present disclosure. In a very basic configuration 402, computing device 400 typically includes one or more processors 404 and a system memory 406. A memory bus 408 may he used for communicating between processor 404 and system memory 406.

Depending on the desired configuration, processor 404 may be of any type including but not limited to a microprocessor (μP), a microcontroller (μC), a digital signal processor (DSP), or any combination thereof. Processor 404 may include one more levels of caching, such as a level one cache 410 and a level two cache 412, a processor core 414, and registers 416. An example processor core 414 may include an arithmetic logic unit (ALU), a floating point unit (FPU), a digital signal processing core (DSP Core), or any combination thereof. An example memory controller 418 may also be used with processor 404, or in some implementations memory controller 418 may be an internal part of processor 404.

Depending on the desired configuration, system memory 406 may be of any type including but not limited to volatile memory (such as RAM), non-volatile memory (such as ROM, flash memory, etc.) or any combination thereof. System memory 406 may include an operating system 420, one or more applications 422, and program data 424. Application 422 may include an adjustable pressure microreactor algorithm 426 that is arranged to perform the functions as described herein including those described with respect to system 100 of FIGS. 1-4. Program data 424 may include adjustable pressure microreactor data 428 that may be useful for adjusting pressure in a microreactor as is described herein. In some embodiments, application 422 may be arranged to operate with program data 424 on operating system 420 such that an adjustable pressure microreactor algorithm protocol may be provided. This described basic configuration 402 is illustrated in FIG. 6 by those components within the inner dashed line.

Computing device 400 may have additional features or functionality, and additional interfaces to facilitate communications between basic configuration 402 and any required devices and interfaces. For example, a bus/interface controller 430 may be used to facilitate communications between basic configuration 402 and one or more data storage devices 432 via a storage interface bus 434. Data storage devices 432 may be removable storage devices 436, non-removable storage devices 438, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 406, removable storage devices 436 and non-removable storage devices 438 are examples of computer storage media. Computer storage media includes, but is not limited to, RAM, ROM, EPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 400. Any such computer storage media may be part of computing device 400.

Computing device 400 may also include an interface bus 440 for facilitating communication from various interface devices (e.g., output devices 442, peripheral interfaces 444, and communication devices 446) to basic configuration 402 via bus/interface controller 430. Example output devices 442 include a graphics processing unit 448 and an audio processing unit 450, which may be configured to communicate to various external devices such as a display or speakers via one or more A/V ports 452. Example peripheral interfaces 444 include a serial interface controller 454 or a parallel interlace controller 456, which may be configured to communicate with external devices such as input devices (e.g., keyboard, mouse, pen, voice input device, touch input device, etc.) or other peripheral devices (e.g., printer, scanner, etc.) via one or more I/O ports 458. An example communication device 446 includes a network controller 460, which may be arranged to facilitate communications with one or more other computing devices 462 over a network communication link via one or more communication ports 464.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF). microwave, infrared (IR) and other wireless media. The term computer readable media as used herein may include both storage media and communication media.

Computing device 400 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 400 may also be implemented as a personal computer including both laptop computer and non-laptop computer configurations.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will he further understood by those within the art that if a specific number clan introduced claim recitation is intended, such an intent will be

explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g.,“ a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can he easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to.” “at least,” “greater than.” “less than.” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for adjusting a pressure in a microreactor system, the microreactor system including a reaction chamber, wherein the reaction chamber is effective to receive at least one reactant, and carry out a reaction on the reactant to produce a product, the method comprising:
controlling a first and second electroosmotic pump to generate a pressure inside the reaction chamber that is greater than one atmosphere, wherein the first electroosmotic pump is controlled effective to drive a first fluid to a first port of the reaction chamber in a first direction with a first force, and wherein the second electroosmotic pump is controlled effective to drive a second fluid to a second port of the reaction chamber in a second direction with a second force, wherein the first and second ports are distinct, and the first and second directions are distinct; and
carrying out the reaction on the reactants in the reaction chamber to produce the product, wherein the reaction is carried out while the first electroosmotic pump drives the first fluid to the reaction chamber and while the second electroosmotic pump drives the second fluid to the reaction chamber.

2. The method as recited in claim 1, wherein the first force is equal to the second force.

3. The method as recited in claim 1, wherein the first force is greater than the second force.

4. The method as recited in claim 1, further comprising controlling the second electroosmotic pump to drive the second fluid away from the reaction chamber after carrying out the reaction.

5. The method as recited in claim 2, further comprising, after carrying out the reaction:
controlling the second electroosmotic pump to drive the second fluid to the reaction chamber at a third force, wherein the third force is less than the first force.

6. The method as recited in claim 2, further comprising, after carrying out the reaction:
controlling the second electroosmotic pump to drive the second fluid away from the reaction chamber.

7. The method as recited in claim 1, further comprising:
configuring a first voltage source and a second voltage source effective to generate a first voltage to control the first electroosmotic pump and a second voltage to control the second electroosmotic pump, respectively.

8. The method as recited in claim 7, wherein configuring the first voltage source and the second voltage source comprises configuring the first and second voltage sources with a processor.

9. The method as recited in claim 8, wherein configuring the first and second voltage sources with a processor includes configuring the processor to generate the first and second voltages based on a set of instructions stored in a memory in communication with the processor.

10. The method as recited in claim 9, further comprising controlling the first and second electroosmotic pumps so that the first fluid, the second fluid, and the product flow toward an outlet.

11. The method as recited in claim 10, further comprising:
receiving, by the processor, a first signal from a pressure sensor inside the reaction chamber, the first signal relating to a pressure inside the reaction chamber;
receiving, by the processor, a second signal from a flow sensor inside the outlet, the second signal relating to a flow of the second fluid in the outlet; and
controlling, by the processor, the first and second voltage sources based on the first signal, the second signal and the set of instructions.

12. The method as recited in claim 11, further comprising controlling, by the processor a heat source to heat the reaction chamber based on the set of instructions.

13. The method as recited in claim 11, wherein receiving, by the processor, the second signal includes receiving the second signal from a piezoelectric film.

14. The method as recited in claim 1, further comprising controlling a heat source to heat the reaction chamber.

15. The method as recited in claim 1, further comprising:
controlling the first electroosmotic pump including two electrodes to drive a first electrolyte solution to the reaction chamber with the first force; and
controlling the second electroosmotic pump including two electrodes to drive a second electrolyte solution to the reaction chamber with the second force.

16. The method as recited in claim 1, further comprising: driving the first fluid from a reservoir to the reaction chamber with the first electroosmotic pump.

17. An adjustable pressure microreactor system comprising:
a reaction chamber including a first port and a second port;
a first channel in fluid communication with the first part;
a second channel in fluid communication with the second port;
a first electroosmotic pump configured to drive a first fluid to the reaction chamber in a first direction via the first channel with a first force; and
a second electroosmotic pump configured to drive a second fluid to the reaction chamber in a second direction via the second channel with a second force, wherein the first and second directions are distinct;
wherein the reaction chamber, the first channel, the second channel, the first electroosmotic pump and the second electroosmotic pump are configured in cooperation with one another such that first and the second forces are effective to generate a pressure inside the reaction chamber, the pressure being greater than one atmosphere.

18. The adjustable pressure microreactor as recited in claim 17, wherein the first force is equal to the second force.

19. The adjustable pressure microreactor as recited in claim 17, wherein the first force is greater than the second force.

20. The adjustable pressure microreactor as recited in claim 17, wherein the second electroosmotic pump is further effective to drive the second fluid away from the reaction chamber.

21. The adjustable pressure microreactor as recited in claim 18, wherein the second electroosmotic pump is further effective to drive the second fluid to the reaction chamber at a third force, wherein the third force is less than the first force.

22. The adjustable pressure microreactor as recited in claim 18, wherein the second electroosmotic pump is further effective to drive the second fluid away from the reaction chamber.

23. The adjustable pressure microreactor as recited in claim 17, further comprising:
a first voltage source effective to generate a first voltage to control the first electroosmotic pump; and
a second voltage source effective to generate a second voltage to control the second electroosmotic pump.

24. The adjustable pressure microreactor as recited in claim 23, further comprising:
a processor configured in communication with the first and second voltage sources, the processor effective to generate voltage signals, the voltage signals effective to control the first and second voltage sources.

25. The adjustable pressure microreactor as recited in claim 24, further comprising a memory configured in communication with the processor, the memory including a set of instructions, wherein the processor is configured to generate the voltage signals based on the set of instructions.

26. The adjustable pressure microreactor as recited in claim 25, further comprising:
an outlet configured in fluid communication with the second electroosmotic pump;
a pressure sensor located inside the reaction chamber, the pressure sensor effective to generate a first signal relating to a pressure inside the reaction chamber;
a flow sensor located inside the outlet, the flow sensor effective to generate a second signal relating to a flow of the second fluid in the outlet; and
wherein the processor is configured to receive the first signal and the second signal and configured to control the first and second voltage sources based on the first signal, the second signal and the set of instructions.

27. The adjustable pressure microreactor as recited in claim 26, wherein the processor is further configured to control a heat source to heat the reaction chamber based on the set of instructions.

28. The adjustable pressure microreactor as recited in claim 20, wherein
the first electroosmotic pump includes two electrodes;
the first fluid is an electrolyte solution;
the second electroosmotic pump includes two electrodes; and
the second fluid is an electrolyte solution.

29. A computer storage medium having computer-executable instructions stored thereon which, when executed by a computing device, adapt the computing device to perform a method for adjusting a pressure in a microreactor system, the microreactor system including a reaction chamber, wherein the reaction chamber is effective to receive at least one reactant, and carry out a reaction on the reactant to produce a product, the method comprising:
controlling a first and second electroosmotic pump to generate a pressure inside the reaction chamber that is greater than one atmosphere, wherein the first electroosmotic pump is controlled effective to drive a first fluid to a first port of the reaction chamber in a first direction with a first force and the second electroosmotic pump is controlled effective to drive a second fluid to a second port of the reaction chamber in a second direction with a second force, wherein the first and second polls are distinct, and the first and second directions are distinct; and
carrying out the reaction on the reactants in the reaction chamber to produce the product, wherein the reaction is carried out while the first electroosmotic pump drives the first fluid to the reaction chamber and while the second electroosmotic pump drives the second fluid to the reaction chamber.

30. The computer readable storage medium as recited in claim 29, wherein the method further comprises controlling the second electroosmotic pump to drive the second fluid away from the reaction chamber after carrying out the reaction.

31. An adjustable pressure microreactor system comprising:
a reaction chamber including a first port and a second port;
a first channel in fluid communication with the first port:
a second channel in fluid communication with the second port;
a flexible membrane disposed in the second channel, wherein the flexible membrane is configured to selectively change a size of an opening of the second channel;
a first electroosmotic pump configured to drive a first fluid toward to the reaction chamber via the first channel;
a second electroosmotic pump in fluid communication with the flexible membrane, the second electroosmotic pump including a second fluid and configured to selectively move the second fluid to expand the membrane and decrease an opening of the second channel so that, in cooperation with the reaction chamber, the first channel, the second channel, and the first electroosmotic pump, a pressure is generated inside the reaction chamber that is greater than one atmosphere.

32. The adjustable pressure microreactor system as recited in claim 31, wherein the second electroosmotic pump is further effect to move the second fluid to contract the membrane and increase the opening of the second channel.

33. A method for adjusting a pressure in a microreactor system, the microreactor system including a reaction chamber, wherein the reaction chamber is effective to receive at least one reactant, and carry out a reaction on the reactant to produce a product, the reaction chamber including a first opening in fluid communication with a first channel and a second opening in fluid communication with a second channel, the method comprising:
controlling a first electroosmotic pump to drive a first fluid toward to the reaction chamber with a first force;
controlling a second electroosmotic pump to move a second fluid to expand a membrane inside the second channel and decrease an opening of the second channel so that a pressure is generated inside the reaction chamber that is greater than one atmosphere; and
carrying out the reaction on the reactants in the reaction chamber to produce the product, wherein the reaction is carried out while the first electroosmotic pump drives the first fluid to the reaction chamber and while the second electroosmotic pump moves the second fluid to expand the membrane.

34. The method as recited in claim 33, further comprising:
controlling the second electroosmotic pump to move the second fluid to contract the membrane and increase the opening of the second channel.

35. A computer storage medium having computer-executable instructions stored thereon which, when executed by a computing device, adapt the computing device to perform a method for adjusting a pressure in a microreactor system, the microreactor system including a reaction chamber, wherein the reaction chamber is effective to receive at least one reactant, and carry out a reaction on the reactant to produce a product, the reaction chamber including a first opening in fluid communication with a first channel and a second opening in fluid communication with a second channel, the method comprising:
controlling a first electroosmotic pump to drive a first fluid to the reaction chamber with a first force;
controlling a second electroosmotic pump to move a second fluid to expand a membrane inside the second channel and decrease an opening of the second channel so that a pressure is generated inside the reaction chamber that is greater than one atmosphere; and
carrying out the reaction on the reactants in the reaction chamber to produce the product, wherein the reaction is carried out while the first electroosmotic pump drives the first fluid to the reaction chamber and while the second electroosmotic pump moves the second fluid to expand the membrane.

36. The computer readable storage medium as recited in claim 35, wherein the method further comprises:
controlling the second electroosmotic pump to move the second fluid to contract the membrane and increase the opening of the second channel.
